(19) United States
(12) Patent Application Publication
(10) Pub. No.: US 2021/0408825 A1
(43) Pub. Date: Dec. 30, 2021

(54) GLOBAL IRRADIANCE DECOMPOSITION METHODS AND SYSTEMS EXPLOITING SKY CONDITION CLASSIFICATION

(71) Applicants: VIKTAR TATSIANKOU, OTTAWA (CA); KARIN HINZER, OTTAWA (CA); HENRY SCHRIEMER, ASHTON (CA); RICHARD BEAL, OTTAWA (CA)

(72) Inventors: VIKTAR TATSIANKOU, OTTAWA (CA); KARIN HINZER, OTTAWA (CA); HENRY SCHRIEMER, ASHTON (CA); RICHARD BEAL, OTTAWA (CA)

(21) Appl. No.: 17/355,560

(22) Filed: Jun. 23, 2021

Related U.S. Application Data
(60) Provisional application No. 63/044,633, filed on Jun. 26, 2020.

(51) Int. Cl. H02J 13/00; G01W 1/10

(52) U.S. Cl. CPC H02J 13/00019; H02J 2300/26; G01W 1/10; H02J 13/00002

(57) ABSTRACT

The measurement of solar irradiance measurement have important applications, including solar resource assessment, solar power plants, photovoltaic system monitoring, heating and cooling loads of buildings, climate modeling and weather forecasting. An option to establish this is to solely measure the global horizontal irradiance and employ an irradiance decomposition algorithm to derive direct normal irradiance and diffuse horizontal irradiance. However, these models vary in complexity and generally have a relatively high uncertainty particularly between latitudes +60° N and −45° S these errors which includes large portions of North America, Europe, Russia, and Asia where the applications are centered. The inventors have established an improved methodology based upon an improved decomposition algorithm yielding improved accuracy in derived solar irradiance measurements in conjunction with a low cost non-moving part spectral pyranometer supporting spectral global irradiance measurements and spectral clearness indices.

### CROSS-REFERENCE TO RELATED APPLICATIONS

This application claims the benefit of priority from U.S. Provisional Patent Application 63/044,633 filed Jun. 26, 2020.

### FIELD OF THE INVENTION

This patent application relates to solar energy resource assessment systems and more particularly to a decomposition of broadband direct normal and diffuse horizontal irradiances from spectral global horizontal irradiance measurements and multi-wavelength spectral clearness indices for establishing solar energy resource assessments.

### BACKGROUND OF THE INVENTION

Solar irradiance is the power per unit area received from the Sun in the form of electromagnetic radiation, either across a wavelength range or as reported in the wavelength range of a measuring instrument. Solar irradiance is often integrated over a given time period in order to report the radiant energy emitted into the surrounding environment during that time period. This integrated solar irradiance is called solar irradiation, solar exposure, solar insolation, or insolation. Solar irradiance at the Earth's surface is a function of the Earth's distance from the Sun, the solar cycle, the tilt of the measuring surface, the height of the sun above the horizon, and atmospheric conditions.

Solar irradiance affects plant metabolism and animal behavior, including human behaviour. The measurement of solar irradiance has several important applications, including for example solar resource assessment, solar power plants, photovoltaic system monitoring, heating and cooling loads of buildings, climate modeling and weather forecasting.

Sunlight at the earth's surface is typically represented by three irradiances, the global horizontal irradiance (GHI), the direct normal irradiance (DNI) and the diffuse horizontal irradiance (DHI). Of the three, GHI measurements are by far the most common because they only require a relatively inexpensive, low maintenance pyranometer statically mounted on a flat surface. In contrast, obtaining measurements of DNI and DHI requires both a pyrheliometer and a pyranometer (with a shadow ball assembly) mounted to a solar tracker. For cost-sensitive applications, such as obtaining measurements at solar cell deployments etc. it is possible to use “tracker-less” options to derive the GHI, DNI and DHI with a single instrument such as a rotating shadow band radiometer or a shadow-mask pyranometer but the resultant measurements have a higher uncertainty than the aforementioned methods.

An alternative convenient option is to solely measure the GHI and then use an irradiance decomposition algorithm to derive the DNI and/or DHI. These models vary in complexity and generally have a relatively high uncertainty. For example, root mean square (RMS) errors for DNI retrieval of −85 W/m²′ at hourly resolution. Accordingly, for an unbiased distribution this represents a standard deviation of DNI of average daily DNI of 2,000 W/m² this represents an RMS error of 4.25% and at 4,000 W/m² 2.1%. As evident from FIG. 1 which depicts the long term daily average and yearly sum direct normal irradiance around the globe between latitudes +60° N and −45° S these errors are significant across a large portion of North America, Europe, Russia, and Asia where the applications of solar power plants, photovoltaic system monitoring, heating and cooling loads of buildings, climate modeling and weather forecasting are centered.

Accordingly, it would be beneficial to establish an improved methodology based upon an improved decomposition algorithm allowing for improved accuracy in derived solar irradiance measurements in conjunction with a low cost non-moving part spectral pyranometer supporting spectral global irradiance measurements and spectral clearness indices.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to solar energy resource assessment systems and more particularly to a decomposition of direct normal and diffuse horizontal irradiances from spectral global horizontal irradiance measurements and multi-wavelength spectral clearness indices for establishing solar energy resource assessments.

In accordance with an embodiment of the invention there is provided a system comprising:

a spectral measurement device comprising:
a first assembly for establishing a plurality of first outputs where each first output of the plurality of first outputs is an electrical signal generated in dependence upon optical signals received by the spectral measurement device within a predetermined wavelength range; and
a second assembly for establishing a plurality of second outputs where each second output of the plurality of second outputs is an electrical signal generated in dependence upon a sensor associated with the spectral measurement device; and
   a processing system comprising a processor, a memory and computer executable instructions stored within the memory where the computer executable instructions when executed by the processor configure the processor to perform a process comprising the steps of:
establish a plurality of channel measurements, each channel measurement of the plurality of channel measurements being generated in dependence upon a predetermined first output of the plurality of first outputs generated by the spectral measurement device;
establish a plurality of environmental measurements, each environmental measurement of the plurality of environmental measurements being generated in dependence upon a predetermined second output of the plurality of second outputs;
derive a spectral global horizontal irradiance in dependence upon a predetermined subset of the plurality of channel measurements, a predetermined subset of the environmental measurements, and a radiative transfer model;
integrate the spectral global horizontal irradiance to calculate a broadband global horizontal irradiance (GHI);
calculate a spectral clearness index generated in dependence upon a first predetermined subset of the plurality of first outputs;
automatically establish a sky condition in dependence upon a second predetermined subset of the plurality of first outputs; and
execute a decomposition algorithm upon the derived spectral GHI which employs the plurality of spectral clearness indices and the sky condition.

In accordance with an embodiment of the invention there is provided a system comprising:

a processing system comprising a processor, a memory and computer executable instructions stored within the memory where the computer executable instructions when executed by the processor configure the processor to perform a process comprising the steps of:
establish a plurality of channel measurements, each channel measurement of the plurality of channel measurements being generated in dependence upon a predetermined first output of the plurality of first outputs generated by the spectral measurement device;
establish a plurality of environmental measurements, each environmental measurement of the plurality of environmental measurements being generated in dependence upon a predetermined second output of the plurality of second outputs;
derive a spectral global horizontal irradiance in dependence upon a predetermined subset of the plurality of channel measurements, a predetermined subset of the environmental measurements, and a radiative transfer model;
integrate the spectral global horizontal irradiance to calculate a broadband global horizontal irradiance (GHI);
calculate a spectral clearness index generated in dependence upon a first predetermined subset of the plurality of first outputs;
automatically establish a sky condition in dependence upon a second predetermined subset of the plurality of first outputs; and
execute a decomposition algorithm upon the calculated GHI which employs the plurality of spectral clearness indices and the sky condition.

In accordance with an embodiment of the invention there is provided a system comprising:

a processing system comprising a processor, a memory and computer executable instructions stored within the memory where the computer executable instructions when executed by the processor configure the processor to perform a process comprising the steps of:
retrieving a plurality of outputs from a spectral measurement system, each output of the plurality of outputs established in dependence upon optical signals received by the spectral measurement system with a predetermined range of optical wavelengths;
automatically establishing a sky condition in dependence upon a predetermined subset of the plurality of outputs comprises:
   establishing two or more clear sky indices of a plurality of clear sky indices, each clear sky index of the plurality of clear sky indices established in dependence upon a predetermined portion of the predetermined subset of the plurality of outputs;
   establishing the sky condition in dependence upon the two or more clear sky indices.

In accordance with an embodiment of the invention there is provided a system comprising:

a processing system comprising a processor, a memory and computer executable instructions stored within the memory where the computer executable instructions when executed by the processor configure the processor to perform a process comprising the steps of:
retrieving a plurality of outputs generated by a spectral measurement system, each output of the plurality of outputs established in dependence upon optical signals received by the spectral measurement system with a predetermined range of optical wavelengths;
generating a spectral global horizontal irradiance in dependence upon a further predetermined subset of the plurality of outputs;
automatically establishing a sky condition in dependence upon a predetermined subset of the plurality of outputs;
generating a plurality of spectral clearness indices, each spectral clearness index of the plurality of spectral clearness indicates generated in dependence upon a predetermined out of the plurality of outputs by:
   retrieving a set of coefficients established in dependence upon the automatically established sky condition where each coefficient of the set of coefficients is associated with a predetermined spectral clearness index of the plurality of spectral clearness indices; and
   multiplying each spectral clearness index of the plurality of spectral clearness indices by its associated coefficient of the set of coefficients; and
executing a decomposition algorithm upon the generated spectral global horizontal irradiance.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts the long term daily average and yearly sum direct normal irradiance around the globe between latitudes +60° N and −45° S;

FIG. 2A depicts an exemplary compact self-contained no-moving part spectral pyranometer supporting spectral global irradiance measurements and spectral clearness indices supporting embodiments of the invention;

FIG. 2B depicts exploded perspective views of the spectral pyranometer supporting spectral global irradiance measurements and spectral clearness indices supporting embodiments of the invention as depicted in FIG. 2A;

FIG. 3 depicts an exemplary assembly structure and data flow for the spectral pyranometer supporting spectral global irradiance measurements and spectral clearness indices supporting embodiments of the invention as depicted in FIG. 2A; and

FIG. 4 depicts an exemplary processing flow for result generation for a spectral pyranometer supporting spectral global irradiance measurements and spectral clearness indices supporting embodiments of the invention as depicted in FIG. 2A.

FIG. 5 depicts an exemplary process flow according to an embodiment of the invention for spectral reconstruction using spectral data obtained from a spectral pyranometer supporting spectral global irradiance measurements and spectral clearness indices such as depicted in FIG. 2A;

FIG. 6 depicts an exemplary process flow for calibrating a spectral pyranometer supporting spectral global irradiance measurements and spectral clearness indices such as depicted in FIG. 2A;

FIG. 7 depicts an exemplary process flow according to an embodiment of the invention employing a radiative transfer model to derive spectral global irradiance using spectral data obtained from a spectral pyranometer supporting spectral global irradiance measurements and spectral clearness indices such as depicted in FIG. 2A;

FIG. 8 depicts an exemplary process flow according to an embodiment of the invention for decomposing the broadband direct normal and diffuse horizontal irradiances using spectral global horizontal data obtained from a spectral pyranometer supporting spectral global irradiance measurements and spectral clearness indices such as depicted in FIG. 2A;

FIG. 9 depicts the derived coefficients for the DNI estimation for a specific sky condition according to an embodiment of the invention; and

FIG. 10 depicts error distributions derived from the process described in FIG. 8 for direct normal and diffuse irradiances derived from spectral data obtained from a spectral pyranometer supporting spectral global irradiance measurements and spectral clearness indices such as depicted in FIG. 2A against a reference instrument.

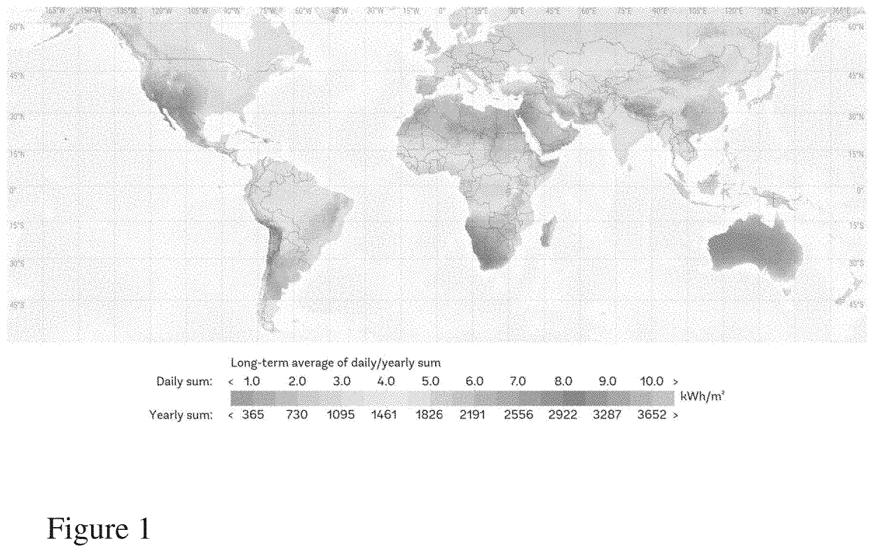

### DETAILED DESCRIPTION

The present invention is directed to solar energy resource assessment systems and more particularly to a decomposition of broadband direct normal and diffuse horizontal irradiances from spectral global horizontal irradiance measurements and multi-wavelength spectral clearness indices for establishing solar energy resource assessments.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers, or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “pyranometer” as used herein and throughout this disclosure may refer to, but is not limited to, a type of actinometer used for measuring solar irradiance on a planar surface and it is designed to measure the solar radiation flux density (W/m²) from the hemisphere above within a wavelength range, for example 300 nm to 3 μm.

A “pyrheliometer” as used herein and throughout this disclosure may refer to, but is not limited to, an instrument for measurement of direct beam solar irradiance.

As noted above it would be beneficial to establish an improved methodology based upon an improved decomposition algorithm allowing for improved accuracy in derived solar irradiance measurements in conjunction with a low cost non-moving part spectral pyranometer supporting spectral global irradiance measurements and spectral clearness indices. To date the majority of decomposition algorithms have been based on a clearness index. which is a unitless measure of the atmosphere's clearness, derived from the product of the local GHI and the airmass divided by the extraterrestrial irradiance. Some models have improved the decomposition results by also including the atmospheric turbidity and total column water vapor (i.e. the precipitable water vapor) into the calculations. The additional insight from local atmospheric parameters translates to improved model performance.

A comprehensive way to assess the atmospheric conditions is to use local spectral irradiance data. which historically has been difficult to obtain. as it requires several co-located field spectroradiometers. However, with the advent of compact, field deployable, relative low cost spectral pyranometers, such as the “SolarSIM-G” developed by the inventors and sold by Spectrafy Inc. of Ottawa, Canada, it is now possible to obtain full-range spectral and broadband GHI data from a single compact. low power instrument with no moving parts. Accordingly, the inventors have established a methodology exploiting temporally based (e.g. one minute) spectral measurements using such a spectral pyranometer to derive spectral clearness indices at multiple wavelengths. These are then employed as predictors within the novel decomposition algorithm according to an embodiment of the invention.

A: Spectral Pyranometer

A spectral pyranometer such as the SolarSIM-G is an instrument for resolving the global spectral and broadband irradiance over a predetermined wavelength range, for example 280 nm≤λ≤4000 nm as described below. Accordingly, the SolarSIM-G combines the capabilities from multiple instruments such as a spectroradiometer and a pyranometer all in one single compact housing.

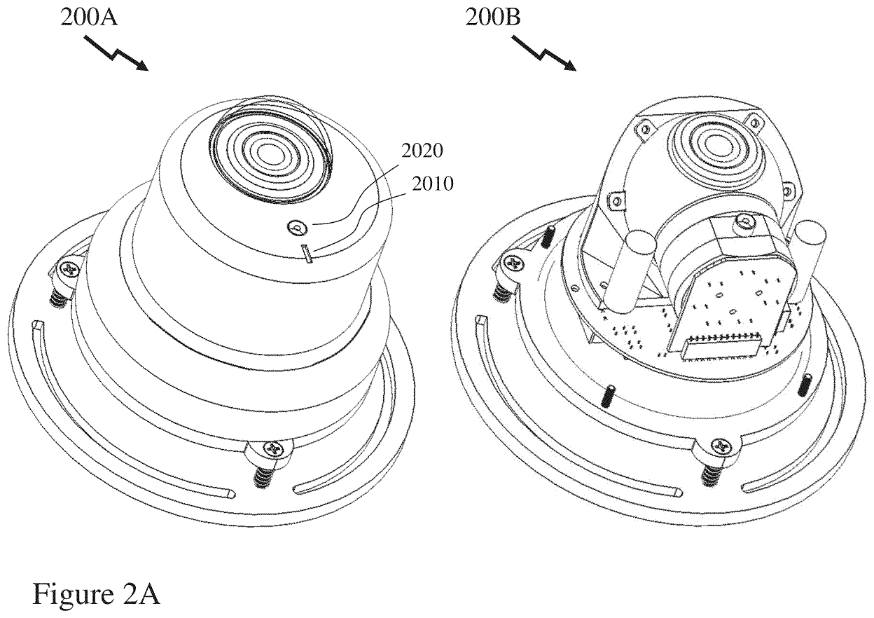

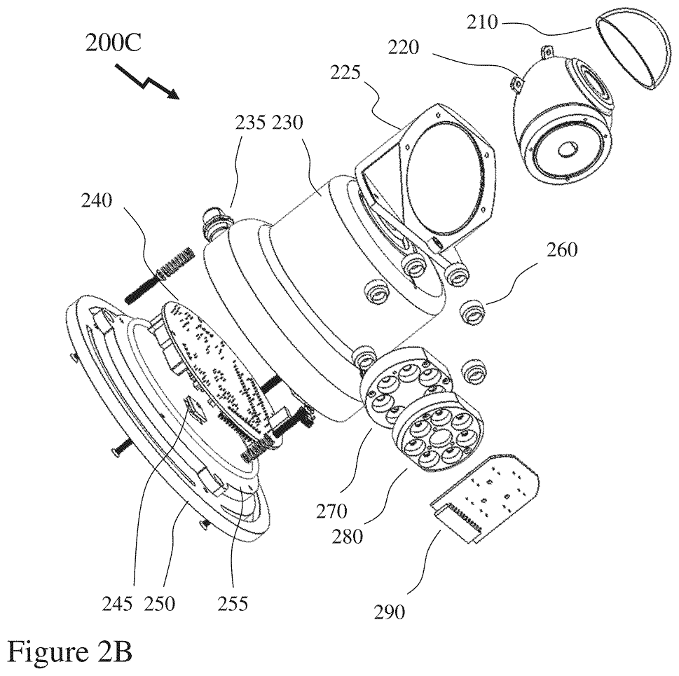

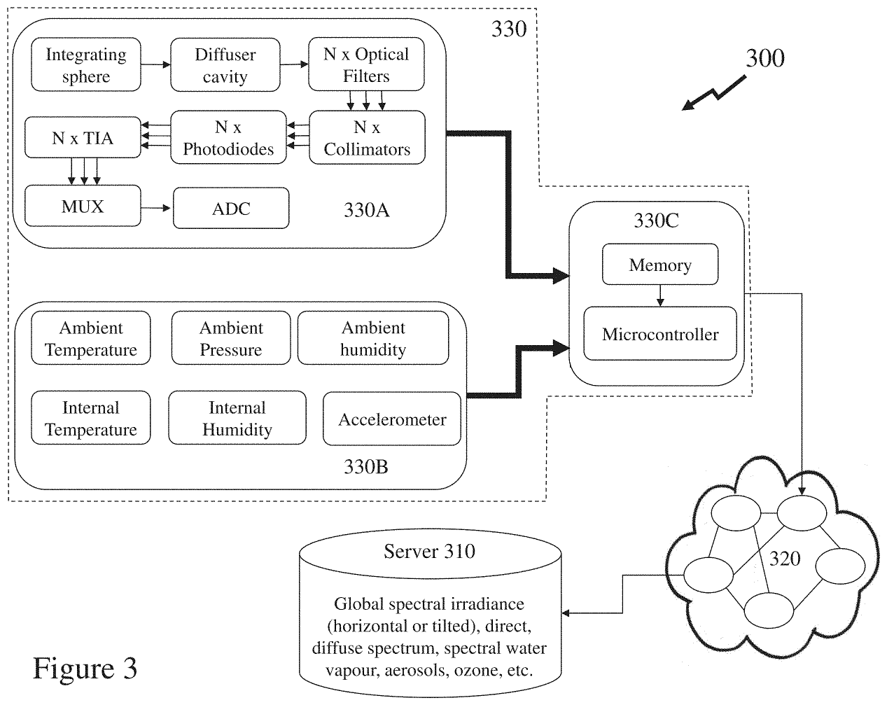

Referring to FIG. 2A there are depicted first and second three-dimensional (3D) perspective views 200A and 200B respectively of a SolarSIM-G with and without a protective dome and outer mechanical housing attached. Disposed within the top surface of the SolarSIM-G as depicted in first 3D perspective views 200A are a tilt bubble 2010 and a solar noon indicator 2010. The solar noon indicator 2010 when the SolarSIM-G is deployed should be positioned so that it points toward the solar noon at the location of the SolarSIM-G installation, for example due south in the northern hemisphere. It would be evident from FIG. 2B that the optical train from the integrating sphere (spherical diffuser) lies along this line such that the optical collimators are aligned north-south.

In FIG. 2B there is depicted a first 3D exploded perspective view 200C of the SolarSIM-G of FIG. 2A. The SolarSIM-G depicted in FIGS. 2A and 2B is depicted as a 7 channel design operating over a predetermined wavelength range, e.g. 280 nm≤λ≤4000 nm. However, it would be evident that other channel counts may be employed including the 9 channels employed in the subsequent description. Accordingly, as depicted within FIG. 2B in first 3D exploded perspective view 200C the elements identified are:
Protective dome 210;
Upper diffuser body 220;
Lower diffuser body 225;
Outer mechanical housing 230;
Electrical connector 235;
Electrical circuit board 240;
Ambient environment sensor(s) 245;
Mounting plate 250;
SolarSIM-G base plate 255;
Optical filter assembly 260;
First optical collimator element 270;
Second optical collimator element 280; and
Photodetector circuit board 290.

Accordingly, the SolarSIM-G is an instrument that combines a multi-filter radiometer with an advanced radiative transfer model to derive in real-time full-range spectral and broadband global irradiances under all sky conditions. The SolarSIM-G measures the global spectral irradiance using hard-coated narrow bandpass filters paired with silicon and indium gallium arsenide calibrated detectors. The center wavelengths for the 9 channel SolarSIM-G employed are given in Table 1 along with the atmospheric parameters or conditions that these wavelengths are targeted at. The SolarSIM-G also senses the ambient temperature, humidity and atmospheric pressure. These radiance and environmental measurements then fed into the inventor's radiative transfer model to derive the spectral and broadband GHI in the 280 nm≤λ≤4000 nm range.

TABLE 1
Channel Listing of 9 Channel SolarSIM-G

| Channel | Centre Wavelength (nm) | Resolves |
|---|---|---|
| 1 | <420 | Aerosols, diffuse |
| 2 | 420 | Aerosols, diffuse |
| 3 | 500 | Aerosols, diffuse |
| 4 | 610 | Ozone |
| 5 | 675 | Aerosols, diffuse |
| 6 | 880 | Aerosols, diffuse |
| 7 | 940 | Water vapour |
| 8 | >1000 | Aerosols, cloud |
| 9 | >1000 | Aerosols, cloud |

Now referring to FIG. 16 there is depicted an exemplary system block diagram 300 of a SolarSIM-G 330 such as depicted in FIGS. 2A and 2B respectively comprising first to third functional blocks 330A, 330B and 330C. As depicted first functional block 1600A relates to the multiple wavelength channels and consists of integrating sphere (spherical diffuser) and diffuser cavity which are common to all channels and then for each wavelength channel an optical filter and optical collimator assembly coupled to a photodiode. The outputs from the multiple photodetectors are coupled via an array of transimpedance amplifiers (TIAs) to an electrical multiplexer. The output of the multiplexer is converted to digital form via an analog-to-digital converter (ADC). The output of the ADC is coupled to the electronic functional block 330C. Within other devices photodetector may have an associated TIA and the multiple TIA outputs are multiplexed for the ADC or even multiple ADCs may be employed. Optionally, the outputs from the photodetectors are multiplexed prior to being amplified by a TIA and digitized.

Second functional block 330B relates to the other sensors within the SolarSIM-G 330 including, but not limited to, ambient temperature, ambient pressure, ambient humidity, internal temperature, internal humidity, and accelerometer. The outputs of these being also coupled to the electronic functional block 330C.

The electronic functional block 330C therefore receives multiplexed digital data relating to the multiple wavelength channels and digital data from multiple environmental sensors. These are processed by a microcontroller within the electronic functional block 330C via a software algorithm or software algorithms stored in memory associated with the microcontroller. The electronic functional block 330C also implements one or more communication protocols such that the raw and/or processed data are pushed to or pulled to a host computer, in this instance a remote server 310 via a network 320. The remote server 310 may process the data from the SolarSIM-G 330 or stores processed data from the SolarSIM-G 330. This data may include, but is not limited to, global spectral irradiance (horizontal or titled), direct spectrum, diffuse spectrum, spectral water vapour, aerosols, and ozone absorption profiles. Optionally, the data acquired by the SolarSIM-G 330 is processed directly onboard the SolarSIM-G 330 prior to being transmitted to the remote server 310 or another device via the network 320. Accordingly, the SolarSIM-G 330 may employ one or more wireless interfaces to communicate with the network 320 selected from the group comprising, but not limited to, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. Alternatively, the SolarSIM-G 330 may employ one or more wired interfaces to communicate with the network 320 selected from the group comprising, but not limited to, DSL, Dial-Up, DOCSIS, Ethernet, G.hn, ISDN, MoCA, PON, and Power Line Communication (PLC).

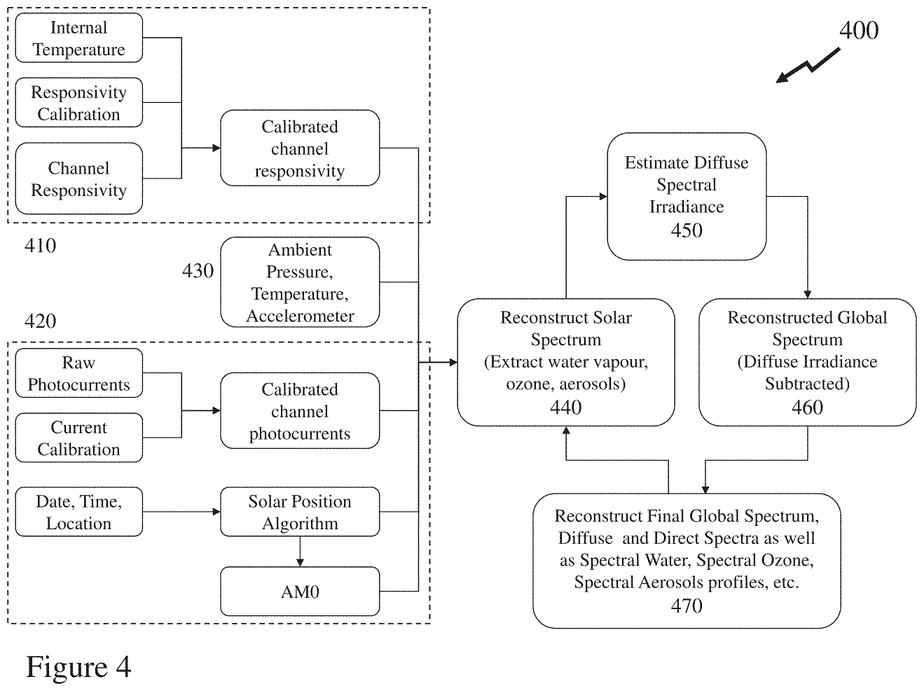

A software block diagram for the software algorithm of a SolarSIM-G is depicted in FIG. 4 comprising. As indicated all of the inputs on the left are fed to a series of initial processing algorithms and subsequent reconstruction algorithms in order to resolve the global, direct, and diffuse solar spectrum. Accordingly, as indicated first block 410 establishes the channel responsivity for each wavelength channel where these are derived in dependence upon the internal SolarSIM-G temperature, the channel responsivity calibration and the channel responsivity. Within second block 420 the raw digitized photocurrents and current calibration data are then used to generate calibrated channel photocurrents. Also, within this block the date, time, and location information are employed within a solar position algorithm which is employed in generating the air mass zero (AM0) spectrum which is that of the sun with no intervening atmosphere. These outputs are combined with accelerometer, ambient pressure and ambient temperature data generated by third block 430 within a fourth block 440 which employs an initial algorithm to derive a reconstructed solar spectrum with extracted water vapour, aerosols, and ozone as a result of the wavelengths selected for the SolarSIM-G.

Next in fifth block 450 the diffuse spectral irradiance is estimated and then employed to generate a refined reconstructed solar spectrum in sixth block 460 which is then employed to reconstruct the final global spectrum, diffuse and direct spectra as well as the atmospheric absorption profiles for water, ozone, and aerosols in seventh block 470. As the global spectrum is a combination of the direct and the diffuse spectral irradiances, the first reconstruction will not be perfect, as we are not taking the diffuse irradiance into account. However, the reconstructed proxy spectrum allows estimating the aerosols, water vapour and ozone content in the atmosphere, which in turn allow a better approximation of the diffuse irradiance. The approximated diffuse irradiance is then subtracted from the proxy global solar spectrum and reconstruction is performed once again, which gives the direct component of the global spectral irradiance. Addition of the estimated diffuse spectral irradiance to the direct component yields the global spectral irradiance.

B: Spectral Reconstruction Algorithm

The spectral reconstruction algorithm according to embodiments of the invention comprises three steps:
Calibrate the Instrument;
Acquire Real-Time Data; and
Employ Radiative Transfer Model.

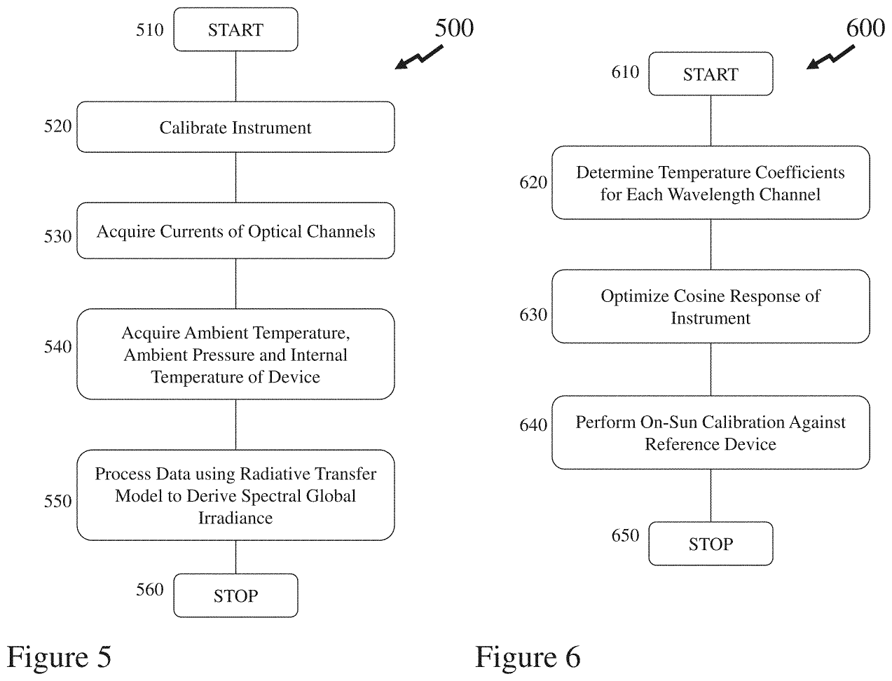

FIG. 5 depicts an exemplary process flow 500 according to an embodiment of the invention for spectral reconstruction using spectral data obtained from a spectral pyranometer supporting spectral global irradiance measurements and spectral clearness indices such as depicted in FIGS. 2A and 2B respectively. As depicted, process flow 500 comprises first to sixth steps comprising:
First step 510 wherein the calibration process starts;
Second step 520 wherein the instrument is calibrated;
Third step 530 wherein the photocurrents of the photodetectors within the instrument are acquired;
Fourth step 540 wherein the ambient temperature, ambient pressure, and internal temperature of the device are acquired;
Fifth step 550 wherein the photocurrents and environmental data are processed using a radiative transfer model to derive the spectral global irradiance; and
Sixth step 560 wherein the process stops.

Accordingly, referring to FIG. 6 there is depicted an exemplary process flow 600 for calibrating a spectral pyranometer supporting spectral global irradiance measurements and spectral clearness indices such as depicted in FIGS. 2A and 2B. Exemplary process flow 600 representing an exemplary process flow for second step 520 in exemplary process flow 500 in FIG. 5. As depicted the process flow 600 comprises first to fifth steps 610 to 650 respectively, these being:
First step 610 wherein the calibration process starts;
Second step 620 wherein the temperature coefficients for each wavelength channel are determined;
Third step 630 wherein the cosine response is optimized to comply with class A pyranometer requirements as defined by ISO 9060: 2018 standard “Solar Energy-Specification and Classification of Instruments for Measuring Hemispherical Solar and Direct Solar Radiation”;
Fourth step 640 wherein on-sun calibration is performed against a reference SolarSIM-G or a reference spectroradiometer; and
Fifth step 650 wherein the calibration process stops.

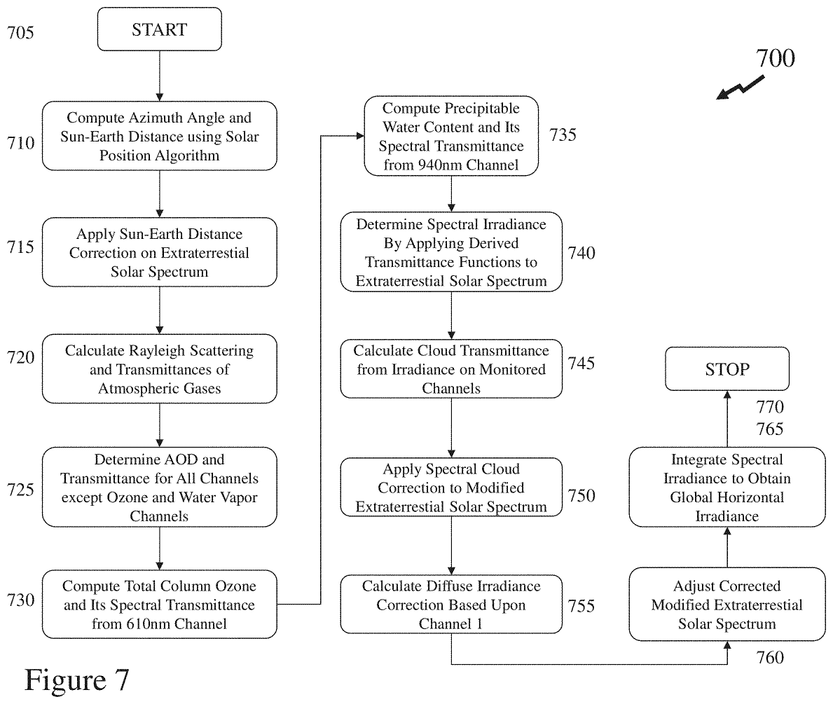

Referring to FIG. 7 depicts an exemplary process flow 700 according to an embodiment of the invention employing a radiative transfer model to derive spectral global irradiance using spectral data obtained from a spectral pyranometer supporting spectral global irradiance measurements and spectral clearness indices such as depicted in FIGS. 2A and 2B. Exemplary process flow 600 representing an exemplary process flow for fifth step 550 in exemplary process flow 500 in FIG. 5. As depicted first to fourteenth steps 705 to 770 respectively provide for spectral global irradiance in the 280 nm≤λ≤4000 nm range using a SolarSIM-G. However, it would be evident that the process flow 700 works for wavelength ranges within range as well as for the full range. These steps comprising:
First step 705 wherein the process starts;
Second step 710 wherein the zenith angle and the sun-earth distance are calculated using a solar position algorithm;
Third step 715 wherein a sun-earth distance correction is applied to an extraterrestrial solar spectrum;
Fourth step 720 wherein Rayleigh scattering is calculated together with the transmittances of various atmospheric gases, for example carbon dioxide (CO₂), methane (CH₄), oxygen (O₂), and nitrogen oxide (NO₂);
Fifth step 725 wherein the spectral aerosol optical depth (AOD) and its transmittance are determined from all wavelength channels except the ozone channel (channel 4; λ=610 nm) and the water vapor channel (channel 7, λ=940 nm);
Sixth step 730 wherein the total column ozone and its spectral transmittance are established using the data from the λ=610 nm channel;
Seventh step 735 wherein the precipitable water vapor content and its spectral transmittance are established using the data from the λ=940 nm channel;
Eighth step 740 wherein the spectral irradiance is calculated by applying the derived transmittance functions from fourth to seventh steps 720 to 735 to the extraterrestrial solar spectrum established in third step 715;
Ninth step 745 wherein the cloud transmittance is calculated based on the irradiance at the two long wavelength channels 8 and 9 respectively (λ>1000 nm);
Tenth step 750 wherein the spectral cloud correction established in ninth step 745 is applied to the spectrum from eighth step 740 in the 1000 nm≤λ≤4000 nm range;
Eleventh step 755 wherein a diffuse irradiance correction is calculated based upon the short wavelength irradiance established from channel 1 (λ<420 nm);
Twelfth step 760 wherein the spectrum from tenth step 750 is adjusted in dependence upon the short wavelength diffuse irradiance correction established in eleventh step 755 for the 280 nm≤λ≤360 nm range;
Thirteenth step 765 wherein the spectral irradiance established in twelfth step 760 is integrated to yield the GHI; and a Fourteenth step 770 wherein the process stops.

Accordingly, based upon exemplary process flow 700 the GHI is derived from real-time multi-wavelength spectral data obtained with the SolarSIM-G.

C: Experimental Data Set

In order to verify the improvements from the novel methodology established by the inventors spectral and broadband irradiance data were obtained from five “stations” across a range of environments as outlined in Table 2: Four stations form part of the Canadian Spectral Irradiance Network operated by Spectrafy whilst the fifth was operated by the Institute of Atmospheric Physics in the People's Republic of China. Each station being equipped with a SolarSIM-G as manufactured by Spectrafy Inc. together with a second device, a SolarSIM-D2 also manufactured by Spectrafy Inc. The SolarSIM-D2 providing a versatile device providing the functionalities of a pyrheliometer, a spectroradiometer, a sun photometer and an ozone spectrophotometer, all in a single compact rugged unit. The raw data was acquired with one-minute resolution by a datalogger. and subsequently sent to a central server for processing and storage.

TABLE 2
Measurement Stations

| Station | Latitude | Longitude | Altitude | AOD₅₀₀ | Data Range |
|---|---|---|---|---|---|
| Devon | 53.4° | 113.7° | 800 m | 0.14 | 9 months |
| Egbert | 44.2° | 79.8° | 90 m | 0.10 | 21 months |
| Ottawa | 45.4° | 75.7° | 70 m | 0.11 | 23 months |
| Varennes | 45.6° | 73.4° | 60 m | 0.11 | 21 months |
| Xianghe | 39.8° | −117.0° | 36 m | 0.48 | 9 months |

The SolarSIM-D2 provides the spectral and broadband DNI in the 280 nm≤λ≤4000 nm range together with spectral AOD in the 280 nm≤λ≤4000 nm range, total column ozone and the precipitable water vapor. The SolarSIM-G delivers the spectral and broadband GHI in the 280 nm≤λ≤4000 nm range. By combining the measurements from both instruments, the inventors computed the spectral and broadband DHI in the 280 nm≤λ≤4000 nm range.

The data sets from each location end by 1 Dec. 2019 and vary in length from 9 to 24 months. Aggregated they are equivalent to almost seven years of acquired data at one-minute granularity. The data sets were carefully screened and validated. Data for solar elevation angles less than 100 were excluded to minimize horizon perturbations and to avoid any effects from shadowing. Data taken during periods of snow, rain or maintenance were likewise excluded. Three of the stations, Egbert. Ottawa. and Varennes, operate under similar atmospheric conditions. Their mean AODs at λ=500 nm (AOD₅₀₀) as listed in Table 2 being near or at 0.1. The other two stations show greater diversity in atmospheric conditions. The Devon station has slightly heavier AOD₅₀₀ loading at 0.14, whilst the Xianghe station in China has a mean AOD₅₀₀ of 0.48. The combined data set represents a diverse range of environmental conditions representative of many locations around the world.

D. Global Irradiance Decomposition

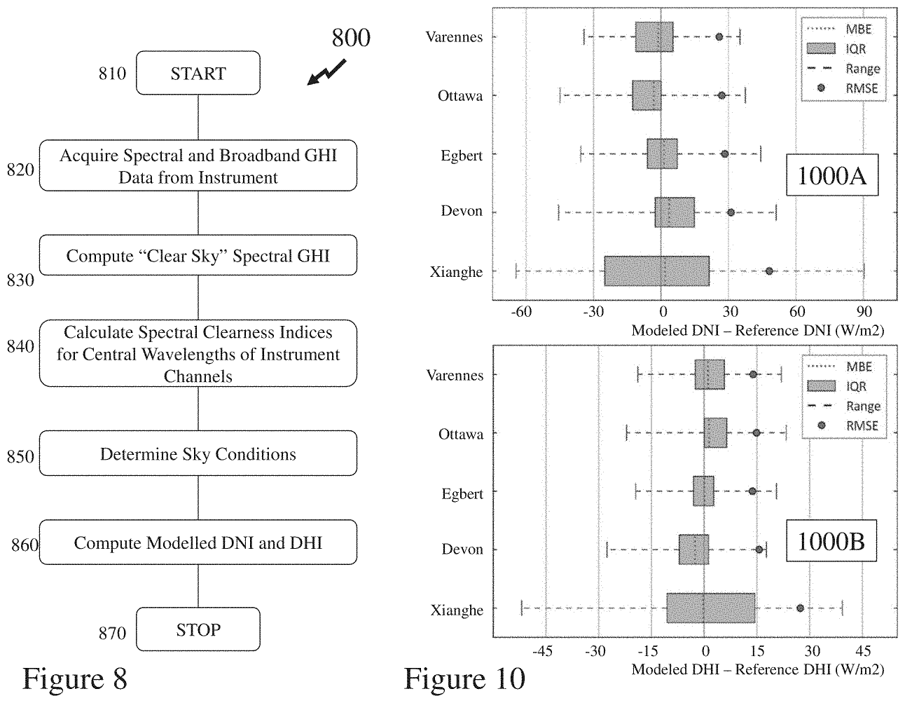

DNI and DHI data may be extracted from the SolarSIM-G's GHI data. The algorithm for its extraction as described below and depicted in respect of exemplary process flow 800 in FIG. 8 followed by an overview of the spectral clearness index, its application as a predictor of sky conditions and its subsequent employment in the computation of the DNI and DHI.

D1: Decomposition Algorithm

FIG. 8 depicts an exemplary process flow 800 according to an embodiment of the invention for decomposing the direct normal and diffuse horizontal irradiances using spectral data obtained from a spectral pyranometer supporting spectral global irradiance measurements and spectral clearness indices such as depicted in FIGS. 2A and 2B. As depicted process flow 800 comprises first to seventh steps 801 to 870 wherein these comprise:
First step 810 wherein the process starts;
Second step 820 wherein spectral and broadband GHI data are acquired from the instrument, e.g. SolarSIM-G;
Third step 830 wherein the “clear-sky” spectral GHI is calculated from the data acquired in second step 820 from Equation (1);
Fourth step 840 wherein spectral clearness indices are calculated for the central wavelengths of all monitored channels, e.g. the SolarSIM-G's channels, using Equation (2);
Fifth step 850 wherein the sky condition is determined using a classification table (such as that given in Table 3 for example according to an embodiment of the invention);
Sixth step 860 wherein the modelled DNI and DHI are calculated using Equations (3) and (4) respectively; and
Seventh step 870 wherein the process stops.

S_{GHI,CLR}(λ)=S_{DNI,CLR}(λ)·m⁻¹+S_{DHI,CLR}(λ) (1)

κ(λ)=S_{GHI}(λ)/S_{GHI,CLR}(λ) (2)

I_{DNI,MOD}=α_{1,X}·I_{GHI}·m+α_{2,X}·I_{DNI,CLR}+Σ_{I=1,I≠7}⁹β_{I,X}·κ(λ_{I}) (3)

I_{DHI}=I_{GHI}−I_{DNI}·m⁻¹ (4)

D2: Spectral Clearness Index

We start by defining the “clear-sky” spectral global horizontal irradiance by Equation (1) where S_{DNI,CLR}(λ) and S_{DHI,CLR}(λ) are the modelled “clear-sky” spectral DNI and spectral DHI respectively, in the 280 nm≤λ≤4000 nm range, and m is the optical air mass. The DNI is obtained through a parameterized direct beam transmittance model such as presented by the inventors within “Design Principles and Field Performance of a Solar Spectral Irradiance Meter” (Solar Energy, Vol. 133, pp. 94-102, 2016), except the aerosol transmittance is generated by fixing the AOD at λ=500 nm to 0.05 with its spectral dependence defined by two Angstrom exponents of 0.98 and 1.22 for wavelengths λ<500 nm and λ>500 nm respectively. The spectral ozone and water vapor transmittance functions are generated from the total column ozone and precipitable water vapor content obtained by the SolarSIM-G measurements. Finally. the modelled “clear-sky” spectral DHI in the 280 nm≤λ≤4000 nm is based upon a predetermined model, for example R. Bird et al. “Simple Solar Spectral Model for Direct and Diffuse Irradiance on Horizontal and Tilted Planes at the Earth's Surface for Cloudless Atmospheres” (J. Climate and Applied Meteorology, Vol. 25, pp. 87-97, 1986).

Accordingly, for a more comprehensive measure of the atmosphere's clearness the inventors define κ(λ) as given by Equation (2) as the spectral clearness where S_{GHI}(λ) is the measured spectral GHI as derived by the SolarSIM-G, and S_{GHI,CLR}(λ) is the modelled “clear-sky” spectral GHI. computed from Equation (1).

D3. Classification of Sky Conditions

The inventors have established a crucial insight leveraged in their decomposition algorithm which is based upon similar atmospheric conditions correlate with sky conditions. Accordingly, a classification can be employed as discussed above wherein an exemplary classification is presented in Table 3. Within this the inventors categorize sky conditions into seven classes based on the values of the spectral clearness indices κ(λ₁) and κ(λ₉), which are established using optical channels 1 and 9 of the SolarSIM-G respectively. These two channels were chosen by the inventors as after analysis the spectral clearness indices at these wavelengths show the strongest sensitivity to sky conditions. Channel 1 was chosen by the inventors because it is the most sensitive to small changes in the diffuse irradiance, whilst channel 9 was chosen because it is the least sensitive to the clear-sky diffuse irradiance and to the aerosol absorption of the direct beam. As a result. channel 9 is the most sensitive channel to cloud absorption and scattering and is accordingly a reasonable estimator of the clouds' optical depth that obscure the sun.

TABLE 3
Classification of Sky Conditions based upon Clearness Indices
at Two Wavelengths (Channels 1 and 9 of a SolarSIM-G)

| | | |
|---|---|---|
| Sky | κ(λ₁) | κ(λ₉) |

| Condition | X | Min. | Max. | Min. | Max. |
|---|---|---|---|---|---|
| Very Clear | 1 | 1.00 | — | 0.75 | 1.05 |
| Clear | 2 | 0.80 | 1.00 | 0.75 | 1.05 |
| Hazy | 3 | — | 0.80 | 0.75 | 1.05 |
| Thin Cloud | 4 | — | — | 0.50 | 0.75 |
| Thick Cloud | 5 | — | — | 0.25 | 0.50 |
| Overcast | 6 | — | — | — | 0.25 |
| Lensing | 7 | — | — | 1.05 | — |

As indicated in Table 3 the inventor's classification of sky clarity is quantified by index ranges. It would be apparent that beneficially, this inventive dual-wavelength spectral classification can be automatically established and employed within instruments, systems and software exploiting embodiments of the invention. Whilst the embodiments of the invention described employ two channels for sky condition determination it would be evident that 3, 4, or more wavelengths may be employed within other embodiments of the invention.

Based on the AOD₅₀₀ data from all stations the inventors established that values for κ(λ₉) of 0.75 and above correlate with an unobstructed sun disk for over 95% of the data. When the sky is free of clouds. the values of κ(λ₁) can be used to further characterize the sky as either “very clear”. “clear”, or “hazy”. When the sky is cloudy. but the sun disk is not obscured, the GHI in some cases can exceed the solar constant. This is the special case of lensing. where κ(λ₉) is found to exceed 1.05.

The inventors also established that values of κ(λ₉) below 0.75 correlated with a sun obstructed by the clouds for over 90% of the data. as determined by the SolarSIM-D2's AOD₅₀₀ measurements at each station. Decreasing values of κ(λ₉) were found by the inventors to correlate well with cloud optical depth. allowing “thin” clouds, “thick” clouds, and completely overcast conditions to be identified by their κ(λ₉) ranges.

D4: Computation of DNI and DHI

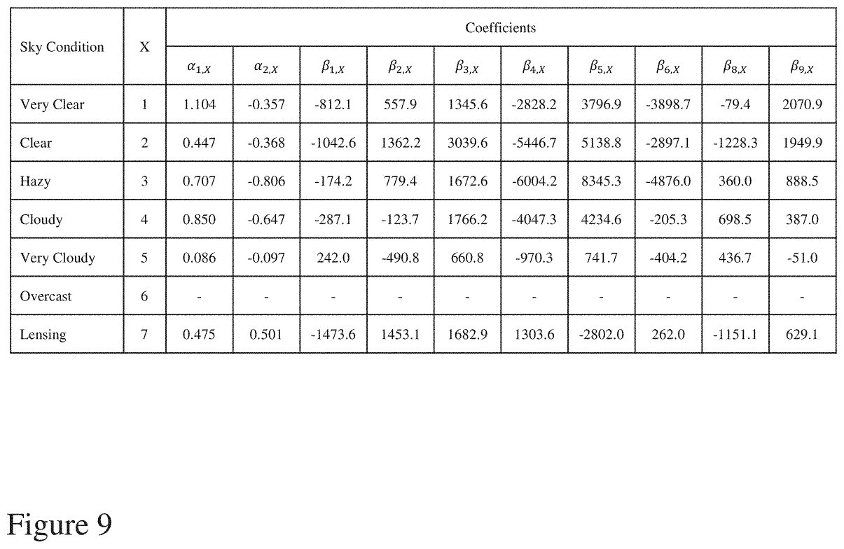

For a specific sky condition X (as defined in Table 3) the decomposition of the modelled DNI may be parameterized as given by Equation (3) where I_{GHI} is the measured broadband GHI; I_{DNI,CLR} is the integral of the modeled “clear-sky” spectral DNI, S_{DNI,CLR}(λ), in the 280 nm≤λ≤4000 nm; α_{1,X} and α_{2,X} are unitless coefficients for the broadband predictors, I_{GHI} and I_{DNI,CLR}, respectively; P_{I}, is a set of eight coefficients for spectral clearness indices at the center wavelengths of all SolarSIM-G's optical channels, except for the water vapor channel, i.e. channel 7. This channel is excluded because variation in the total column water vapor is already captured within the I_{GHI} and I_{DNI,CLR} variables. The α and β coefficients for each sky condition X were determined using a multivariate ordinary least squares linear regression algorithm that minimized the difference between the modelled DNI and the measured DNI time series from all stations at the same time. These coefficients are presented in FIG. 9 for all sky conditions except when it is overcast in which case the modeled DNI is set to zero. The DHI can be computed from the GHI and the DNI as given by Equation (4).

E: Analysis

The performance of the inventive decomposition algorithm was established by comparing modeled DNI and DHI time series at each station against their corresponding references values. The reference DNI was determined from the SolarSIM-D2 measurements at each station whilst the reference DNI was computed from Equation (4) using the reference DNI and GHI. as derived by the SolarSIM-D2 and the SolarSIM-G, respectively, at each station. The inventors have assumed that any differences between reference instruments and derived DNI and DHI values are dominated by the limitations of the decomposition algorithm. Therefore. reference instrument measurement uncertainties were not included in the comparative analysis (i.e. reference DNI and DHI data were assumed to be true).

Accordingly, the inventors evaluated the decomposition algorithm by calculating various statistical estimators from the difference between the modeled and reference DNI and DHI time series for each station. First and second graphs 1000A and 1000B in FIG. 10 depict boxplot diagrams of the error distributions of the modeled DNI and modeled DHI, respectively. as compared to their corresponding reference measurements at each station. The Interquartile Range (IQR) is defined as the difference between the 75^{th} and 25^{th} percentiles of the data set, while the extended range represents the errors within the 5^{th} and 95^{th} percentiles, which corresponds to approximately ±2σ or 95% coverage, if assuming a normal distribution. The mean bias error (MBE) assesses the average bias in the prediction. while the root mean square error (RMSE) is the standard deviation of the prediction error.

As can be seen from first graph 1000A in FIG. 10 the extended error ranges for DNI retrieval are similar for Ottawa. Varennes and Egbert stations. about ±40 W/m², while the MBE is around −1 W/m² and the RMSE is about 27 W/m². This is expected since these stations are relatively close to each other and are subjected to similar environmental conditions. For Devon station. which has a slightly higher mean AOD₅₀₀ than the aforementioned stations. the extended error range is a bit wider at about ±48 W/m², while the RMSE is similar. For Xianghe station. which experiences large variations in aerosol conditions due to changes in pollution. the extended error range for the DNI is relatively high. ranging from −64 W/m² to +90 W/m², while the RMSE was 48 W/m². This is due to numerous periods at Xianghe when the reduction of GHI irradiance due to aerosol absorption of the direct beam is partially compensated for by the gain in the GHI from the diffuse irradiance due to aerosol scattering. In such cases the algorithm according to an embodiment of the invention as has difficulty differentiating between the “clear”, “hazy”, and “thin clouds” sky conditions, which leads to increased uncertainty for the DNI retrieval. Nonetheless, the MBE for the DNI estimation for all stations is less than 4 W/m^{2.}

The modeled DHI propagates the errors from the modeled DNI. as per Equation (4). The extended error range for Varennes, Ottawa. Egbert stations is about ±21 W/m², while the MBE and the RMSE are +1 W/m² and 14 W/m² respectively. For Devon station the MBE was approximately −3 W/m² with the extended error range stretching from −28 W/m² to +17 W/m², while the RMSE was 15 W/m². Similar to the DNI retrieval, the Xianghe station saw the highest error spread with the extended error range varying from −52 W/m² to +39 W/m², with negligible MBE and the RMSE of 27 W/m².

As noted previously the prior art methodologies yield an RMSE of −85 W/m². Accordingly, for Xianghe station with high variations in aerosol conditions due to changes in pollution the RMSE from the inventive algorithm according to an embodiment of the invention yields an RMSE of 27 W/m², or approximately 30% of the prior art. For stations without such variations in aerosol conditions the RMSE was 15 W/m², or approximately 17% of the prior art.

The inventors also computed the integrated energy per unit surface area errors for the entire DNI and DHI datasets at each station and compared them against the corresponding reference values. The DNI and DHI integrated energy errors were less than 1% and 2%, respectively, at each station. This is an important result as it suggests that even in high aerosol environments, such as Xianghe, the novel decomposition algorithm according to an embodiment of the invention can accurately provide the estimate of the DNI and DHI solar resource potential.

Accordingly, the novel decomposition algorithm demonstrates a significant improvement over state-of-the-art decomposition algorithms, even with a one-minute resolution data set. Furthermore, exploiting a spectral pyranometer such as the SolarSIM-G provides a compact, low cost, non-moving part system solution which presents an alternative to other tracker-less methods for obtaining all three components of sunlight. such as rotating shadow band radiometers and shadow-mask pyranometer. It is expected that the decomposition algorithm can be further improved as more data becomes available from the existing measurement stations and future installations worldwide in order to refine the coefficients.

Potentially, different coefficient sets may be established in different deployment environments such as those with high aerosols/variations in aerosol conditions versus those without such aerosols and/or variations in aerosol conditions.

Within the embodiments of the invention described above specific wavelengths have been defined associated with specific aspects of the process. It would be evident that these specific wavelengths are nominal centre wavelengths for optical filters or other optical spectrometry methods of establishing optical intensity at these nominal centre wavelengths. Further, it would be evident that optical filters or other optical spectrometry methods would perform these measurements with a nominal wavelength range around these nominal centre wavelengths. Within other embodiments of the invention certain wavelengths defined above may be varied and/or augmented with other wavelengths associated with a characteristic being determined. For example, multiple wavelengths may be employed for specific aerosols or different absorption bands of an aerosol or other component of the atmosphere may be employed.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system comprising:
a spectral measurement device comprising:
a first assembly for establishing a plurality of first outputs where each first output of the plurality of first outputs is an electrical signal generated in dependence upon optical signals received by the spectral measurement device within a predetermined wavelength range; and
a second assembly for establishing a plurality of second outputs where each second output of the plurality of second outputs is an electrical signal generated in dependence upon a sensor associated with the spectral measurement device; and
a processing system comprising a processor, a memory and computer executable instructions stored within the memory where the computer executable instructions when executed by the processor configure the processor to perform a process comprising the steps of:
establish a plurality of channel measurements, each channel measurement of the plurality of channel measurements being generated in dependence upon a predetermined first output of the plurality of first outputs generated by the spectral measurement device;
establish a plurality of environmental measurements, each environmental measurement of the plurality of environmental measurements being generated in dependence upon a predetermined second output of the plurality of second outputs;
derive a spectral global horizontal irradiance in dependence upon a predetermined subset of the plurality of channel measurements, a predetermined subset of the environmental measurements, and a radiative transfer model;
integrate the spectral global horizontal irradiance to calculate a broadband global horizontal irradiance (GHI);
calculate a spectral clearness index generated in dependence upon a first predetermined subset of the plurality of first outputs;
automatically establish a sky condition in dependence upon a second predetermined subset of the plurality of first outputs; and
execute a decomposition algorithm upon the derived spectral GHI which employs the plurality of spectral clearness indices and the sky condition.

2. The system according to claim 1, wherein
deriving the spectral global irradiance in dependence upon the predetermined subset of the plurality of channel measurements, the predetermined subset of the environmental measurements, and the radiative transfer model comprises:
1) establishing a zenith angle and a sun-earth distance using a solar position algorithm;
2) applying a sun-earth distance correction to an extraterrestrial solar spectrum in dependence upon the established sun-earth distance;
3) calculating a Rayleigh scattering factor calculated together with the transmittances of a predetermined set of atmospheric gases;
4) calculating a spectral aerosol optical depth and its transmittance in dependence upon a third predetermined subset of the plurality of first outputs;
5) calculating a total column ozone and its spectral transmittance in dependence upon a fourth predetermined subset of the plurality of first outputs;
6) calculating the precipitable water vapor content and its spectral transmittance in dependence upon a fifth predetermined subset of the plurality of first outputs;
7) calculating a spectral irradiance by applying the derived transmittance functions from steps (3) to (6) to the extraterrestrial solar spectrum established in step (2);
8) calculating a cloud transmittance correction in dependence upon a sixth predetermined subset of the plurality of first outputs;
9) applying the cloud transmittance correction established in step (8) to the result of step (7);
10) calculating a diffuse irradiance correction in dependence upon a seventh predetermined subset of the plurality of first outputs; and
11) applying the diffuse irradiance correction established in step (10) to the result of step (9).

3. The system according to claim 1, wherein
calculating a spectral clearness index comprises:
establishing a modelled clear sky spectral GHI; and
calculating the spectral clearness index in dependence upon the measured GHI and the modelled clear sky spectral GHI.

4. The system according to claim 1, wherein
automatically establishing a sky condition in dependence upon a second predetermined subset of the plurality of first outputs comprises:
establishing a first clear sky index in dependence upon a first portion of the second predetermined subset of the plurality of first outputs;
establishing a second clear sky index in dependence upon a second portion of the second predetermined subset of the plurality of first outputs;
establishing the sky condition in dependence upon the first clear sky index and second clear sky index.

5. The system according to claim 1, wherein
executing the decomposition algorithm upon the calculated GHI which employs the plurality of spectral clearness indices and the sky condition comprises the steps of:
retrieving a set of coefficients established in dependence upon the sky condition where each coefficient of the set of coefficients is associated with a predetermined spectral clearness index of the plurality of spectral clearness indices; and
multiplying each spectral clearness index of the plurality of spectral clearness indices by its associated coefficient of the set of coefficients.

6. The system according to claim 1, wherein
the first assembly comprises:
a diffuser disposed in front of a first aperture of a cavity;
a first body portion comprising the first aperture having a first predetermined diameter positioned in a first predetermined position on the first body portion and forming a first predetermined portion of the cavity;
a second body portion comprising a plurality of second apertures, each second aperture having a second predetermined diameter and positioned in a second predetermined position on the second body portion and forming a second predetermined portion of the cavity,
a plurality of optical collimators, each optical collimator coupled to a predetermined second aperture of the plurality of second apertures and defining a maximum angular acceptance angle for each photodetector of a plurality of photodetectors disposed at the distal end of an optical collimator from that coupled to the predetermined second aperture of the plurality of second apertures; and
a plurality of optical filters, each filter having a passband of predetermined optical wavelengths and disposed in combination with a predetermined optical collimator of the plurality of collimators to filter optical signals exiting the second aperture; and
each first output of the plurality of first outputs is generated in dependence upon a photocurrent of a predetermined photodetector of the plurality of photodetectors associated with an optical collimator of the plurality of optical collimators generated by optical signals within the passband of the predetermined optical wavelengths of the optical filter of the plurality of optical filters associated that optical collimator of the plurality of optical collimators.

7. The system according to claim 1, wherein
the first assembly comprises:
a plurality of photodetectors, each photodetector receiving a predetermined wavelength range of the ambient optical environment via an optical path comprising a diffuser element, an optical cavity, a bandpass filter, and an optical collimator to limit the angle of incident ambient light to within a predetermined range; and
an electronic circuit comprising a first portion for digitizing a photocurrent for each photodetector of the plurality of first photodetectors and a second portion for at least one of generating a reconstructed solar spectrum in dependence upon at least the digitized photocurrents of the plurality of photodetectors and a model of the solar spectrum with no atmosphere; wherein
the plurality of detectors are disposed radially around a first portion of the optical cavity disposed opposite an aperture within a second portion of the optical cavity covered by the diffuser element;
the optical cavity for each photodetector of the plurality photodetectors is a cavity common to all of the plurality of photodetectors; and
the diffuser element for each photodetector of the plurality photodetectors is a diffuser common to all of the plurality of photodetectors; and
each first output of the plurality of first outputs is generated in dependence upon a photocurrent of a predetermined photodetector of the plurality of photodetectors generated by optical signals within the predetermined wavelength range established by the bandpass filter within the optical path to that photodetector of the plurality of photodetectors.

8. The system according to claim 1, wherein
the first assembly comprises:
a spherical diffuser comprising a spherical cavity within an outer body, the spherical cavity coated with a first near Lambertian material;
a first aperture of a first predetermined diameter formed in a first predetermined position on the spherical diffuser;
a second aperture of a second predetermined diameter formed in a second predetermined position on the spherical diffuser;
a baffle disposed in a predetermined relationship relative to the first aperture and the second aperture, the baffle having a predetermined thickness, is coated with a second near Lambertian material and is disposed on the inner surface of the spherical diffuser and having a geometry defining a predetermined portion of a sphere;
a plurality of optical collimators coupled to the second aperture and defining a maximum angular acceptance angle for each photodetector of a plurality of photodetectors disposed at the distal end of an optical collimator from that coupled to the second aperture; and
a plurality of optical filters, each filter having a passband of predetermined optical wavelengths and disposed in combination with an optical collimator of the plurality of collimators to filter optical signals exiting the second aperture.
each first output of the plurality of first outputs is generated in dependence upon a photocurrent of a predetermined photodetector of the plurality of photodetectors associated with an optical collimator of the plurality of optical collimators generated by optical signals within the passband of the predetermined optical wavelengths of the optical filter of the plurality of optical filters associated that optical collimator of the plurality of optical collimators.

9. A system comprising:
a processing system comprising a processor, a memory and computer executable instructions stored within the memory where the computer executable instructions when executed by the processor configure the processor to perform a process comprising the steps of:
establish a plurality of channel measurements, each channel measurement of the plurality of channel measurements being generated in dependence upon a predetermined first output of the plurality of first outputs generated by the spectral measurement device;
establish a plurality of environmental measurements, each environmental measurement of the plurality of environmental measurements being generated in dependence upon a predetermined second output of the plurality of second outputs;
derive a spectral global horizontal irradiance in dependence upon a predetermined subset of the plurality of channel measurements, a predetermined subset of the environmental measurements, and a radiative transfer model;
integrate the spectral global horizontal irradiance to calculate a broadband global horizontal irradiance (GHI);
calculate a spectral clearness index generated in dependence upon a first predetermined subset of the plurality of first outputs;
automatically establish a sky condition in dependence upon a second predetermined subset of the plurality of first outputs; and
execute a decomposition algorithm upon the calculated GHI which employs the plurality of spectral clearness indices and the sky condition.

10. The system according to claim 9, wherein
deriving the spectral global irradiance in dependence upon the predetermined subset of the plurality of channel measurements, the predetermined subset of the environmental measurements, and the radiative transfer model comprises:
1) establishing a zenith angle and a sun-earth distance using a solar position algorithm;
2) applying a sun-earth distance correction to an extraterrestrial solar spectrum in dependence upon the established sun-earth distance;
3) calculating a Rayleigh scattering factor calculated together with the transmittances of a predetermined set of atmospheric gases;
4) calculating a spectral aerosol optical depth and its transmittance in dependence upon a third predetermined subset of the plurality of first outputs;
5) calculating a total column ozone and its spectral transmittance in dependence upon a fourth predetermined subset of the plurality of first outputs;
6) calculating the precipitable water vapor content and its spectral transmittance in dependence upon a fifth predetermined subset of the plurality of first outputs;
7) calculating a spectral irradiance by applying the derived transmittance functions from steps (3) to (6) to the extraterrestrial solar spectrum established in step (2);
8) calculating a cloud transmittance correction in dependence upon a sixth predetermined subset of the plurality of first outputs;
9) applying the cloud transmittance correction established in step (8) to the result of step (7);
10) calculating a diffuse irradiance correction in dependence upon a seventh predetermined subset of the plurality of first outputs; and
11) applying the diffuse irradiance correction established in step (10) to the result of step (9).

11. The system according to claim 9, wherein
calculating a spectral clearness index comprises:
establishing a modelled clear sky spectral GHI; and
calculating the spectral clearness index in dependence upon the measured GHI and the modelled clear sky spectral GHI.

12. The system according to claim 9, wherein
automatically establish a sky condition in dependence upon a second predetermined subset of the plurality of first outputs comprises:
establishing a first clear sky index in dependence upon a first portion of the second predetermined subset of the plurality of first outputs;
establishing a second clear sky index in dependence upon a second portion of the second predetermined subset of the plurality of first outputs;
establishing the sky condition in dependence upon the first clear sky index and second clear sky index.

13. The system according to claim 9, wherein
executing the decomposition algorithm upon the calculated GHI which employs the plurality of spectral clearness indices and the sky condition comprises the steps of:
retrieving a set of coefficients established in dependence upon the sky condition where each coefficient of the set of coefficients is associated with a predetermined spectral clearness index of the plurality of spectral clearness indices; and
multiplying each spectral clearness index of the plurality of spectral clearness indices by its associated coefficient of the set of coefficients.

14. The system according to claim 9, wherein
the spectral measurement device comprises:
a first assembly for establishing a plurality of first outputs where each first output of the plurality of first outputs is an electrical signal generated in dependence upon optical signals received by the spectral measurement device within a predetermined wavelength range; and
a second assembly for establishing a plurality of second outputs where each second output of the plurality of second outputs is an electrical signal generated in dependence upon a sensor associated with the spectral measurement device; and
the first assembly comprises:
a diffuser disposed in front of a first aperture of a cavity;
a first body portion comprising the first aperture having a first predetermined diameter positioned in a first predetermined position on the first body portion and forming a first predetermined portion of the cavity;
a second body portion comprising a plurality of second apertures, each second aperture having a second predetermined diameter and positioned in a second predetermined position on the second body portion and forming a second predetermined portion of the cavity;
a plurality of optical collimators, each optical collimator coupled to a predetermined second aperture of the plurality of second apertures and defining a maximum angular acceptance angle for each photodetector of a plurality of photodetectors disposed at the distal end of an optical collimator from that coupled to the predetermined second aperture of the plurality of second apertures; and
a plurality of optical filters, each filter having a passband of predetermined optical wavelengths and disposed in combination with a predetermined optical collimator of the plurality of collimators to filter optical signals exiting the second aperture; and
each first output of the plurality of first outputs is generated in dependence upon a photocurrent of a predetermined photodetector of the plurality of photodetectors associated with an optical collimator of the plurality of optical collimators generated by optical signals within the passband of the predetermined optical wavelengths of the optical filter of the plurality of optical filters associated that optical collimator of the plurality of optical collimators.

15. The system according to claim 9, wherein
the spectral measurement device comprises:
a first assembly for establishing a plurality of first outputs where each first output of the plurality of first outputs is an electrical signal generated in dependence upon optical signals received by the spectral measurement device within a predetermined wavelength range; and
a second assembly for establishing a plurality of second outputs where each second output of the plurality of second outputs is an electrical signal generated in dependence upon a sensor associated with the spectral measurement device; and
the first assembly comprises:
a plurality of photodetectors, each photodetector receiving a predetermined wavelength range of the ambient optical environment via an optical path comprising a diffuser element, an optical cavity, a bandpass filter, and an optical collimator to limit the angle of incident ambient light to within a predetermined range; and
an electronic circuit comprising a first portion for digitizing a photocurrent for each photodetector of the plurality of first photodetectors and a second portion for at least one of generating a reconstructed solar spectrum in dependence upon at least the digitized photocurrents of the plurality of photodetectors and a model of the solar spectrum with no atmosphere; wherein
the plurality of photodetectors are disposed radially around a first portion of the optical cavity disposed opposite an aperture within a second portion of the optical cavity covered by the diffuser element;
the optical cavity for each photodetector of the plurality photodetectors is a cavity common to all of the plurality of photodetectors; and
the diffuser element for each photodetector of the plurality photodetectors is a diffuser common to all of the plurality of photodetectors; and
each first output of the plurality of first outputs is generated in dependence upon a photocurrent of a predetermined photodetector of the plurality of photodetectors generated by optical signals within the predetermined wavelength range established by the bandpass filter within the optical path to that photodetector of the plurality of photodetectors.

16. The system according to claim 9, wherein
the spectral measurement device comprises:
a first assembly for establishing a plurality of first outputs where each first output of the plurality of first outputs is an electrical signal generated in dependence upon optical signals received by the spectral measurement device within a predetermined wavelength range; and
a second assembly for establishing a plurality of second outputs where each second output of the plurality of second outputs is an electrical signal generated in dependence upon a sensor associated with the spectral measurement device; and
the first assembly comprises:
a spherical diffuser comprising a spherical cavity within an outer body, the spherical cavity coated with a first near Lambertian material;
a first aperture of a first predetermined diameter formed in a first predetermined position on the spherical diffuser;
a second aperture of a second predetermined diameter formed in a second predetermined position on the spherical diffuser;
a baffle disposed in a predetermined relationship relative to the first aperture and the second aperture, the baffle having a predetermined thickness, is coated with a second near Lambertian material and is disposed on the inner surface of the spherical diffuser and having a geometry defining a predetermined portion of a sphere;
a plurality of optical collimators coupled to the second aperture and defining a maximum angular acceptance angle for each photodetector of a plurality of photodetectors disposed at the distal end of an optical collimator from that coupled to the second aperture; and
a plurality of optical filters, each filter having a passband of predetermined optical wavelengths and disposed in combination with an optical collimator of the plurality of collimators to filter optical signals exiting the second aperture.
each first output of the plurality of first outputs is generated in dependence upon a photocurrent of a predetermined photodetector of the plurality of photodetectors associated with an optical collimator of the plurality of optical collimators generated by optical signals within the passband of the predetermined optical wavelengths of the optical filter of the plurality of optical filters associated that optical collimator of the plurality of optical collimators.

17. A system comprising:
a processing system comprising a processor, a memory and computer executable instructions stored within the memory where the computer executable instructions when executed by the processor configure the processor to perform a process comprising the steps of:
retrieving a plurality of outputs from a spectral measurement system, each output of the plurality of outputs established in dependence upon optical signals received by the spectral measurement system with a predetermined range of optical wavelengths; and
executing another process.

18. The system according to claim 17, wherein
the another process comprises:
automatically establishing a sky condition in dependence upon a predetermined subset of the plurality of outputs comprises:
establishing two or more clear sky indices of a plurality of clear sky indices, each clear sky index of the plurality of clear sky indices established in dependence upon a predetermined portion of the predetermined subset of the plurality of outputs;
establishing the sky condition in dependence upon the two or more clear sky indices.

19. The system according to claim 18, wherein
the first portion of the second predetermined subset of the plurality of first outputs comprises a first first output generated in dependence upon optical signals received by the spectral measurement device centered around a wavelength shorter than 420 nm;
the second portion of the second predetermined subset of the plurality of first outputs comprises a second first output generated in dependence upon optical signals received by the spectral measurement device centered around a wavelength between 1000 nm and 4000 nm.

20. The system according to claim 18, wherein
establishing the sky condition in dependence upon the two or more clear sky indices comprises performing a look up of a table stored in the memory where for each sky condition within the table a first range is associated with a first clear sky index of the two or more clear sky indices and a second range is associated with a second clear sky index of the two or more clear sky indices; and
at least one of the two or more clear sky indices can exceed unity.

21. The system according to claim 18, wherein
the computer executable instructions further configure the processor to execute a further process comprising:
generating a spectral irradiance in dependence upon a further predetermined subset of the plurality of outputs; and
executing a decomposition algorithm upon the generated spectral irradiance in dependence upon the automatically established sky condition.

22. The system according to claim 21, wherein
the computer executable instructions further configure the processor to execute a further process comprising:
generating a spectral irradiance in dependence upon a further predetermined subset of the plurality of outputs;
executing a decomposition algorithm upon the generated spectral irradiance in dependence upon the automatically established sky condition wherein the decomposition algorithm includes the steps of:
generating a plurality of spectral clearness indices, each spectral clearness index of the plurality of spectral clearness indicates generated in dependence upon a predetermined out of the plurality of outputs;
retrieving a set of coefficients established in dependence upon the automatically established sky condition where each coefficient of the set of coefficients is associated with a predetermined spectral clearness index of the plurality of spectral clearness indices; and
multiplying each spectral clearness index of the plurality of spectral clearness indices by its associated coefficient of the set of coefficients.

23. The system according to claim 17, wherein
the another process comprises:
generating a spectral global horizontal irradiance in dependence upon a further predetermined subset of the plurality of outputs;
automatically establishing a sky condition in dependence upon a predetermined subset of the plurality of outputs;
generating a plurality of spectral clearness indices, each spectral clearness index of the plurality of spectral clearness indicates generated in dependence upon a predetermined out of the plurality of outputs by:
retrieving a set of coefficients established in dependence upon the automatically established sky condition where each coefficient of the set of coefficients is associated with a predetermined spectral clearness index of the plurality of spectral clearness indices; and
multiplying each spectral clearness index of the plurality of spectral clearness indices by its associated coefficient of the set of coefficients; and
executing a decomposition algorithm upon the generated spectral global horizontal irradiance.
